(19) United States
(12) Patent Application Publication
(10) Pub. No.: US 2007/0137590 A1
(43) Pub. Date: Jun. 21, 2007

(54) Internal combustion engine/water source system

(76) Inventor: Jan Vetrovec, Larkspur, CO (US)

Correspondence Address: Jan Vetrovec, P.O. BOX 468, Larkspur, CO, 80118, US

(21) Appl. No.: 11/705,474

(22) Filed: Feb. 12, 2007

Related U.S. Application Data
(63) Continuation-in-part of application No. 11/178,517, filed on Jul. 11, 2005.

(51) Int. Cl. F02B 47/02; F01N 5/02

(52) U.S. Cl. 123/25 A; 60/320

(57) ABSTRACT

An internal combustion engine/water source system for a vehicle powered by a internal combustion engine wherein liquid water is produced by cooling a portion of engine exhaust gases in a vortex tube to induce condensation. In one embodiment, engine exhaust gases are pumped into the vortex tube by a compressor. After removing a portion of water vapor, cooled exhaust gases may be re-introduced to engine's combustion chamber thereby providing an exhaust gas recirculation. In an automotive vehicle, liquid water generated by the invention may be collected and provided to an electrolytic cell for electrolysis into gaseous hydrogen to reduce exhaust pollutants during cold engine start. Alternatively, water generated by the invention may be injected into engine combustion chamber to increase power and to reduce production of nitrogen oxides.

### CROSS-REFERENCE TO RELATED APPLICATIONS

This application is a continuation in-part of prior U.S. application Ser. No. 11/178,517 filed on Jul. 11, 2005 and entitled INTERNAL COMBUSTION ENGINE/WATER SOURCE, the entire contents of which is hereby expressly incorporated by reference.

### FIELD OF THE INVENTION

The present invention relates to an apparatus and method for providing liquid water on-board a vehicle powered by an internal combustion engine and more particularly to supplying water for 1) reducing pollution during cold engine start-up, 2) injection into engine cylinders for improved performance, and 3) reducing turbocharger lag.

### BACKGROUND OF THE INVENTION

There are numerous motivations for producing water onboard a vehicle powered by an internal combustion engine. One such motivation is to provide feedstock for electrolytic generation of hydrogen gas which, during a startup, can be fed into the intake of an internal combustion engine (ICE) to reduce engine wear and/or into an engine exhaust system to reduce pollutants. Another such motivation is injection of water into engine cylinders to increase power output at times of increased demand. Yet another motivation is production of steam for acceleration of turbochargers and reduction of turbocharger response time lag.

Challenges of Cold ICE Startup: There are several problems that must be overcome during the start-up of a cold ICE. First, atomized or vaporous fuel in the air/fuel mixture introduced into the engine cylinders tends to condense onto the cold engine components, such as cylinder walls and the air intake rail. Such a condensate may act as solvents that wash away desirable lubricant films resulting in excessive mechanical wear from reciprocating piston rings in sliding contact with the engine cylinder walls. Second, the condensation of atomized or vaporous fuels onto cold engine cylinder walls may result in poor engine performance and delayed engine availability during and immediately after cold engine start-up. ICE availability may be diminished during cold engine start-up due to poor lubricant properties at low temperatures, non-uniform fuel distribution and improper air/fuel mixtures. Third, if the vehicle is equipped with a catalytic converter increased levels of unwanted pollutants may be emitted from the tailpipe for a period of about one minute after cold engine start-up because that is the amount of time normally needed for the ICE exhaust gases to heat the catalytic converter in the exhaust system to an efficient operating temperature.

The undesirable levels of pollutants released during and immediately after cold engine start-up in automotive vehicles present a problem of increasing importance. In order to meet increasingly stricter governmental engine emission standards, a catalytic converter is usually located in the exhaust stream of the engine. The conventional method of heating the catalytic converter to its efficient operating temperature is to heat the catalyst by passing high temperature exhaust gases from the ICE through the catalyst. Convection heating by exhaust gas in conjunction with the exothermic nature of the oxidation reactions occurring at the catalyst, will usually bring the catalyst to an efficient operating temperature, or “light-off” temperature, in about one minute. However, until the catalyst light-off temperature is reached, the ICE exhaust gasses pass through the catalytic converter relatively unchanged, and unacceptably high levels of pollutants such as carbon monoxide, hydrocarbons and nitrogen oxides are released into the atmosphere. According to some estimates, automotive vehicles having ICE equipped with catalytic converter generate over 80% of the unacceptable emissions or pollutants during cold start operations.

One promising solution to the cold engine start problem is addition of gaseous hydrogen into the fuel mixture before combustion as disclosed, for example, by Andrews et al. in U.S. Pat. No. 6,427,639 and by Murphy et al. in U.S. Pat. No. 6,122,909. When mixed and combusted with engine fuel, the gaseous hydrogen enhances the flame velocity and permits the engine to operate with leaner fuel mixtures. Thus, hydrogen has a catalytic effect causing a more complete burn of the existing fuel and yields a reduction in exhaust emissions. Pollutants may be also reduced by post treatment of ICE exhaust gases by addition of hydrogen as disclosed, for example, by Benninger et al. in U.S. Pat. No. 6,810,657.

Due to the advantages of using hydrogen for reducing ICE exhaust emissions and engine wear during cold startup, a number of attempts have been made to incorporate a hydrogen gas supply system with automotive vehicles. However, providing hydrogen gas as a separate fuel at automotive service stations is impractical because hydrogen distribution infrastructure for automotive use is non-existent. In addition, transport and storage of large quantities of hydrogen represent a very significant safety hazard. This situation may be overcome by producing hydrogen gas directly on board an automotive vehicle by electrolysis of water as disclosed, for example by Andrews et al. in U.S. Pat. No. 6,698,389 and Zagaja et al. in U.S. Pat. Nos. 6,857,397 and 6,659,049. To sustain appropriate hydrogen production rates requires a reliable source of liquid water.

Injection of Water into ICE Combustion Chamber: It is well known in the art that injection of water into ICE combustion chambers reduces flame temperature which translates to reduced NOx emissions. In addition, experiments show that water injection may significantly boost ICE output power.

Turbocharger Response Time Lag: Turbochargers operated by exhaust gas have long been utilized for boosting the power output of ICE's. An exhaust gas turbocharger typically includes a turbine and a centrifugal compressor on a common shaft. The turbine is rotated by exhaust gases from the engine and spins the compressor. The compressor receives intake air, compresses it, and supplies it to ICE combustion chamber(s). Turbochargers provide the advantages of relatively smooth transitions from natural aspiration to supercharged operation while utilizing some of the residual energy of hot exhaust gas, which would otherwise be largely wasted. One drawback of a turbocharged engine is a slow response time known as the “turbo-lag” which is caused by the low pressure and low quantity of exhaust gases at low engine speeds. Quick acceleration of the turbocharger to normal operating speed is further impeded by the turbocharger rotational inertia. Consequently, a standard exhaust gas turbocharger is effective only above about 1800 rpm of the ICE. This means that an ICE equipped with a turbocharger is susceptible to insufficient torque at low engine speeds. An attractive solution recently disclosed by Chomiak in U.S. Pat. No. 6,883,325 uses a steam generated from boiling water to form a jet directed onto the turbine wheel to accelerate the turbocharger. Other uses of water in an automotive vehicle may include replenishment of water in ICE coolant, replenishment of water in windshield washing fluid, and humidity control in passenger compartment.

ICE Exhaust Gas as a Potential Source of Water: It has been earlier recognized that ICE exhaust gases contain a significant amount of water vapor which originates primarily from combustion of fuels containing hydrocarbons. In particular, Andrews et al. in U.S. Pat. No. 6,804,949 teaches that under typical operating conditions ICE exhaust gas stream may contain approximately 12% CO₂, 16% H₂O and 72% of other (mostly nitrogen and inert) gases by volume. Since the ICE exhaust gases may be very hot (typically well over 300 degrees Centigrade), all of the water contained therein may be in the form of vapor. In particular, at sea level (760 Torr total ambient pressure) the partial pressure of water vapor in the ICE gases is about 118 Torr, which translates to a dew point of 55 degrees Centigrade (131 degrees Fahrenheit).

### EXAMPLE 1

To illustrate the potential of ICE exhaust gases as a source of water one may consider an automotive vehicle with an ICE moving at about 100 kilometers per hour (65 miles per hour) and consuming about 1.5 grams of fuel per second. Combustion of fuel at this rate is estimated to generate about 2.1 grams of water vapor per second which translates to about 7.7 kilograms of water per hour. Benz et al. in U.S. Pat. No. 5,658,449 estimates that to support hydrogen production, water should be supplied to an electrolytic cell at a rate of about 35 grams per hour. It is evident that hydrogen production needs on-board the automotive vehicle could be comfortably met by converting only a very small fraction (about 0.5%) of the total available water content in ICE exhaust into liquid water.

It is well known that water condensate forms when gases containing water vapor are cooled to below the dew point. Since ICE exhaust gases passing through an automotive exhaust system are rather hot, they must undergo a very significant cooling before precipitation of liquid water is induced. Information relevant to attempts these problems can be found in U.S. Pat. Nos. 6,804,949, 6,857,397 and 6,659,049. However, each one of these references suffers from one or more of the disadvantages discussed below. In particular, Andrews et al. in U.S. Pat. No. 6,804,949 discloses a method for production of water from ICE exhaust gases wherein ICE exhaust gases are cooled either by ambient air, of by ICE coolant, or by a vapor compression heat pump. However, cooling of exhaust gases to a dew point by ambient air is rather ineffective on hot days when the ambient air temperature approaches the dew point of ICE exhaust gas. Cooling of exhaust gases to a dew point by ICE coolant is effective only during the brief period of ICE startup because the ICE coolant temperature in a fully warmed up engine is typically maintained at about 100 degrees Centigrade. Cooling of exhaust gases to a dew point by a vapor-compression heat pump is not attractive because it requires that an air-conditioning system is actually installed in the vehicle and that it is operated even at times when not necessary for the comfort of vehicle occupants. The latter would undoubtedly result in a very significant wear on the air-condition system and reduced fuel efficiency of the automotive vehicle. Zagaja et al. in U.S. Pat. Nos. 6,857,397 and 6,659,049 discloses a method of cooling ICE exhaust gases using a thermo-electric cooler (TEC). However, TEC is expensive and far less thermodynamically efficient than a vapor compression heat pump, requires significant amount of electric power to operate, and generates significant amount of waste heat that must be rejected.

Vortex Tube: Vortex tube is a well known cooling device in the art of refrigeration. Traditional vortex tube comprises a slender tube having one end closed except for a small a central opening and the other end plugged except for an annular opening which may be adjusted in size for flow control, see FIG. 1. A stream of high-pressure air (or other suitable gas) may be injected through an inlet port tangentially into the tube in the proximity of the central opening. Resulting vortex flow pattern inside the tube separates the input air stream into a relatively hot air stream which exits through the annular opening and a relatively cold air stream which exits through the central opening and the cold outlet port. Relative flow rates and temperatures of these two streams are typically adjustable by controlling the flow of the hot exhaust stream. See, for example, article entitled “The Vortex Tube as a Classic Thermodynamic Refrigeration Cycle,” by B. K. Ahlbom et al., published in Journal of Applied Physics, Volume 88, Number 6, pp. 3645-3653, Sep. 15, 2000. A variant of the traditional vortex tube suitable for generating only a cold output stream can be produced by entirely closing one of the tube ends combined with active cooling of the tube exterior surface such as shown in FIGS. 2A and 2B and disclosed, for example, by Zerr in U.S. Pat. No. 4,612,646. Suitable cooling may be provided by a cooling jacket which may envelop the exterior surface of the tube. Suitable coolants may be provided in liquid or gaseous form. The exterior surface of the tube can be further provided with surface extensions to facilitate improved heat transfer into the coolant as disclosed, for example, by Tunkel et al. in U.S. Pat. No. 5,911,740. Thermodynamic action inside the vortex tube deposits heat into the tube's cooling jacket and it cools the air inside the tube. Vortex tube may also discharge flow into regions of pressures below atmospheric pressure as disclosed, for example, by B. R. Belostotskiy et al. in an article “Vortex-Flow Cooled Laser,” published in Soviet Journal of Optical Technology, volume 35, number 1, pp. 450-452, January-February 1968, and by Tunkel et al. in U.S. Pat. No. 5,561,982. Data of some vortex tube manufacturers suggests that the pressure ratio between vortex tube inlet port and its cold outlet port should be at least 1.4; see, for example, Catalog No. 21, page 102, published by Exair Corporation, Cincinnati, Ohio. Data from vortex tube manufacturers indicates that the practical limit to the reduction in air temperature achievable by a single stage vortex tube is about 70 degrees Centigrade. Vortex tube research data suggests that pressure ratio higher than 8 may cause undesirable pressure shocks inside the vortex tube (see, e.g., B. K. Ahlborn, supra). This suggests that a preferred value for vortex tube pressure ratio should be between about 1.4 and about 8.

Holman et al. in the U.S. Pat. No. 6,895,752 discloses a turbocharged ICE with an exhaust gas recirculation (EGR) system wherein ICE exhaust is directed to a vortex tube to generate a cooler flow and a hoter flow. The cooler flow is directed to ICE intake to recirculate part of the exhaust gas. It is well known that exhaust gases from an ICE may have a temperature generally in the range of 800 to 1,200 degrees Centigrade. Because a single stage vortex tube can only cool gases by about 70 degrees Centigrade and no other cooling means are disclosed by Holman, it may be concluded that the cold output flow from Holmes' vortex tube delivers exhaust gases having a temperature of several hundred degrees Centigrade which is excessively high for condensation of water from a water vapor with a dew point of 55 degrees Centigrade. As a result, Holmes' apparatus is not suitable for production of liquid water from water vapor contained in ICE exhaust gas.

In summary, the referenced art does not teach an ICE system with a water source that is simple and inexpensive to operate. Consequently, there is a great need for new devices and methods for extracting liquid water from ICE exhaust gases. Suitable water source should use very little motive power so as not to significantly reduce vehicle mileage, it should be capable of operating without human intervention in hot, cold, dry, or wet climates and under any weather conditions including freezing conditions, it should be robust to vibrations, and it should be inexpensive to manufacture and integrate into automotive vehicles.

### SUMMARY OF THE INVENTION

The present invention provides an ICE/water source system wherein the water vapor from ICE exhaust gases is condensed into liquid water. A portion of ICE exhaust gases is separated from ICE exhaust gas stream and cooled in a vortex tube to below its dew point. Liquid water generated by the water source may be provided to an electrolytic cell for generation of hydrogen gas, and/or to an injector for delivery into engine combustion chambers, and/or to a steam generator for production of steam to accelerate a turbocharger. Alternate uses of liquid water generated by the water source of the subject invention may include replenishment of water in windshield washing fluid reservoir, replenishment of water in ICE coolant system, and providing a feedstock to a passenger compartment humidifier.

A first embodiment of the present invention may take advantage of the pressure difference between the ICE exhaust and intake passages to operate a vortex tube. In particular, a portion of the ICE exhaust gas is drawn from ICE exhaust duct and pre-cooled in a heat exchanger followed by cooling to below a dew point in a vortex tube. Liquid water is separated from the gases and provided to a reservoir. Exhaust gases with reduced water vapor content separated from liquid water may be drawn into ICE intake or into a suitable source of low pressure.

A second embodiment of the present invention is substantially the same as the first embodiment except that it may also include a compressor which increases the pressure of exhaust gases before they enter the vortex tube. This allows the vortex tube to operate at a higher pressure ratio than in the first embodiment and generate more effective cooling. The compressor can be directly driven by the ICE, vehicle propulsion shaft, air motor, electromagnet, electric motor, or other suitable means. Compression significantly increases a dew point of the ICE exhaust gases. This makes it less challenging to cool the compressed exhaust gases to below the point and induce condensation into liquid water.

A third embodiment of the present invention is particularly suitable for turbocharged ICE. In a turbocharged ICE the exhaust pressure upstream the turbocharger is significantly higher than ambient atmospheric pressure and this pressure head may be used to operate the vortex tube. According to a third embodiment of the present invention, a portion of ICE exhaust gases is drawn from ICE exhaust duct upstream of the turbocharger, pre-cooled in a heat exchanger, and cooled to below its dew point in a vortex tube. Condensed liquid water is substantially separated from gases and collected in a reservoir.

Accordingly, it is an object of the present invention to provide a ICE/water source system which can reliably generate liquid water onboard a vehicle. The ICE/water source system of the present invention has a low energy consumption, is simple, lightweight, and inexpensive to manufacture and, therefore, suitable for large volume production of automotive vehicles.

It is another object of the present invention to provide a ICE/water source system that is operational at all atmospheric conditions, that is robust to freezing conditions, and can operate automatically without human intervention.

It is yet another object of the present invention to provide a ICE/water source system that can supply liquid water to an electrolytic cell for production of gaseous hydrogen that can be injected into ICE intake to improve operation during ICE startup.

It is still another object of the present invention to provide a ICE/water source system that can supply liquid water to an electrolytic cell for production of gaseous hydrogen that can be injected into ICE exhaust to reduce pollutants during ICE startup.

It is a further object of the present invention to provide a ICE/water source system that can supply liquid water for delivery into ICE combustion chambers.

It is a yet further object of object of the present invention to provide a ICE/water source system that can supply liquid water to a steam generator that provides steam for acceleration of a turbocharger.

It is a still further object of object of the present invention to provide a ICE/water source system that can supply liquid water to ICE coolant system.

It is an additional object of object of the present invention to provide a ICE/water source system that can supply liquid water to vehicle windshield washing system.

### BRIEF DESCRIPTION OF THE DRAWINGS

FIG. 1 is a cross-sectional view of a vortex tube of prior art suitable for concurrent generation of hot and cold output streams.

FIG. 2A is a cross-sectional view of a vortex tube of prior art suitable for generation of cold output stream only.

FIG. 2B is a cross-sectional view of an alternative vortex tube of prior art suitabled for generation of cold output stream only.

FIG. 3 is a schematic depiction of the ICE/water source system in accordance with a first embodiment of the subject invention.

FIG. 4 is a schematic depiction of the ICE/water source system in accordance with a second embodiment of the subject invention.

FIG. 5 is a schematic depiction of the ICE/water source system in accordance with a third embodiment of the subject invention.

### DETAILED DESCRIPTION OF THE PREFERRED EMBODIMENTS

Selected embodiments of the present invention will now be explained with reference to drawings. It will be apparent to those skilled in the art from this disclosure that the following descriptions of the embodiments of the present invention are merely exemplary in nature and are in no way intended to limit the invention, its application, or uses.

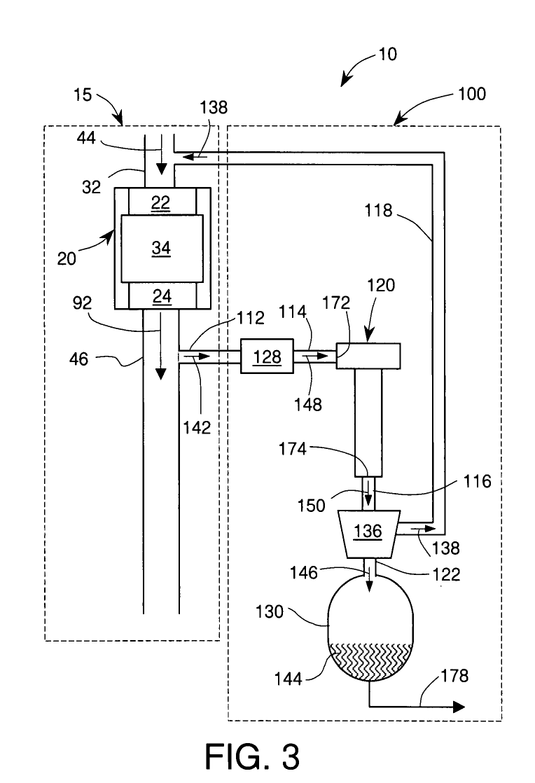

Referring to FIG. 3, there is shown schematically an internal combustion engine (ICE)/water source system 10 in accordance with a first embodiment of the subject invention. The ICE/water source system 10 comprises an ICE assembly 15 and a water source assembly 100. The ICE assembly 15 further comprises an ICE 20, intake duct 32, and exhaust duct 46. The ICE 20 may be of any suitable type adapted for combusting a hydrocarbon-based fuel. For example, the ICE 20 may be a reciprocating type engine having either a compression ignition, spark ignition, or homogeneous charge compression ignition (HCCI). The ICE 20 may further include a combustion chamber 34, an intake passage 22, and an exhaust passage 24. The intake passage 22 is fluidly connected to the intake duct 32 and adapted for receiving intake air therefrom. Furthermore, the intake passage 22 is fluidly connected to the combustion chamber 34 and adapted for flowing intake air threinto. The exhaust passage 24 is fluidly connected to the combustion chamber 34 and adapted for flowing exhaust gases therefrom. Furthermore, the exhaust passage 24 is fluidly connected to the exhaust duct 46 and adapted for flowing exhaust gases thereinto. In an ICE having multiple combustion chambers the intake passage 22 may be formed as an intake manifold and the exhaust passage 24 may be formed as an exhaust manifold. The ICE assembly 15 may also include an electrolytic cell for generation of hydrogen by electrolysis of water, and/or an ICE coolant system, and/or a windshield washing system, and/or a system for injection of liquid water into combustion chamber 34, and/or a system for generation of steam for delivery to a turbine portion of a turbocharger. The water source assembly 100 may further comprise a heat exchanger 128, vortex tube 120, gas-liquid separator 136, reservoir 130, and interconnecting lines 112, 114, 116, 118, and 122.

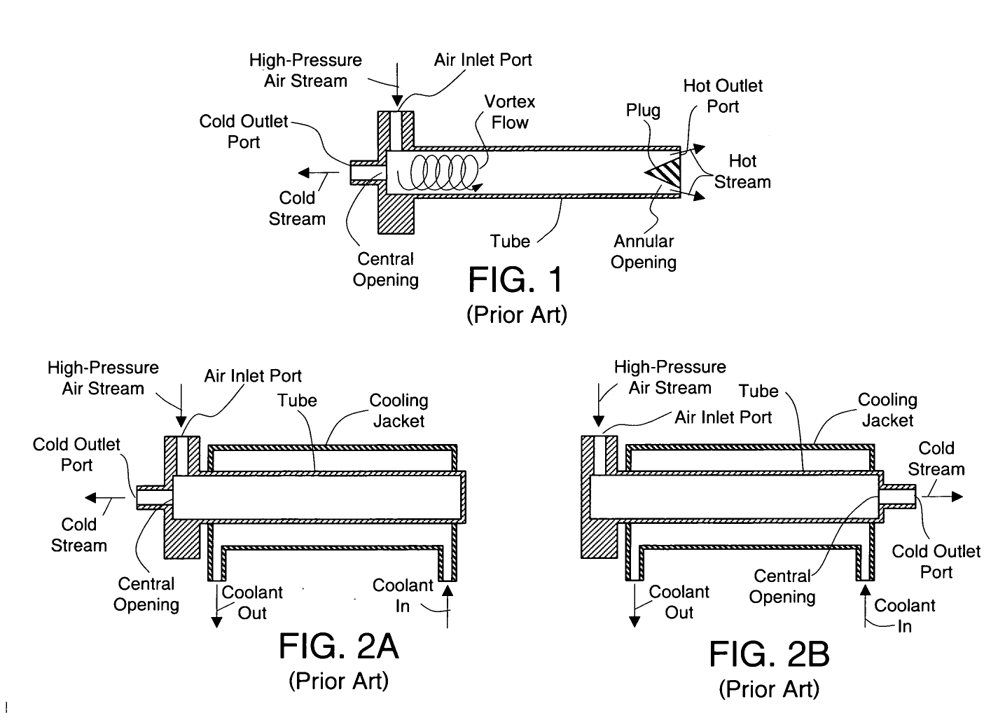

The heat exchanger 128 is adapted for cooling exhaust gases and it may assume a variety of suitable forms practiced in industry. In particular, the heat exchanger 128 may be adapted for transfering heat from exhaust gases into ICE liquid coolant. ICE liquid coolant is preferably provided at a temperature of less than about 100 degrees Centigrade. Most preferably, ICE liquid coolant is provided at a temperature between about 30 and about 60 degrees Centigrade. Alternatively, the heat exchanger 128 may be cooled by ambient air or other suitable means. For example, if the subject invention is used in an automotive vehicle, the heat exchanger 128 (if air cooled) may be located in such a portion of the vehicle where it is exposed to a stream of ambient air induced by the vehicle motion. The heat exchanger 128 has an upstream port fluidly connected to the exhaust duct 46 by means of line 112 and a downstream port fluidly connected to line 114. Line 112 may also include a filter for removal of particulates and a flow control valve (not shown). The vortex tube 120 comprises an inlet port 172 and a cold outlet port 174. Preferably, the vortex tube 120 is of the type adapted for generation of cold air only such as shown in FIGS. 2A and 2B and described in connection therewith. Most preferably, the configuration of vortex tube 120 conforms to FIG. 2B. The vortex tube 120 may also have a cooling jacket (see FIGS. 2A and 2B) which may be cooled by ICE coolant, or by ambient air, or by other suitable means. If ICE coolant is used, it is preferably supplied at a temperature between about 30 and about 60 degrees Centigrade. Preferably, the body of the vortex tube 120 is maintained at a temperature above zero degrees Centigrade to prevent moisture contained in the gases entering the tube from freezing onto tube walls. The design of vortex tube 120 may also include a provision to reduce susceptibility to plugging by ice formed from the residual moisture in the inlet air. Suitable non-freezing vortex tube has been disclosed by Tunkel at al. in U.S. Pat. No. 6,289,679. The inlet port 172 is fluidly connected to the downstream port of heat exchanger 128 via line 114. The cold outlet port 174 is fluidly connected by line 116 to the separator inlet port of gas-liquid separator 136. An alternative vortex tube for use with the subject invention may have a conventional design for concurrent generation of hot and cold outlet streams such as shown in FIG. 1 and described in connection therewith. In such case the vortex tube also includes a hot outlet port which may be fluidly connected to line 118. In addition, such a vortex tube may reject heat into the gas discharged through the hot outlet port. Another alternate vortex tube suitable for use with the subject invention has been disclosed by Cho et al. in U.S. Pat. No. 6,494,935. Cho's vortex tube has the capacity to act as a gas-liquid separator and it may also include a liquid outlet port. Regardless of the type of vortex tube, one or more vortex tubes may be employed in the subject invention. Multiple vortex tubes may be connected in parallel to increase gas through put or in series to increase overall temperature drop in cooled gas.

The gas-liquid separator 136 is adapted for receiving a mixture of gas and liquid through the separator inlet port, substantially separating liquid from the gas, delivering separated liquid substantially free of gas to its liquid output port, and delivering gas substantially free of liquid to its gas outlet port. Gas-liquid separation devices suitable for use with the subject invention may include impingement separators and centrifugal separators such as cyclones and vortex tubes (see, for example, the already mentioned U.S. Pat. No. 6,494,935 to Cho et al. and the U.S. Pat. No. 5,976,227 to Lorey). Certain suitable gas liquid separator may be also found, for example, in Chemical Engineer's Handbook, 5^{th} edition, edited by Robert H. Perry and Cecil H. Chilton, published by Mc-Graw-Hill Book company, New York, N.Y., 1973, chapter 18, section titled “Phase Separation.” The liquid output port of separator 136 may be fluidly connected to the reservoir 130 by means of line 122. The gas output port of separator 130 may be fluidly connected to intake duct 32 by means of line 118. It may be noted that in the configuration shown in FIG. 3, the exhaust duct 46 is fluidly connected to the intake duct 32 by means of the heat exchanger 128, vortex tube 120, gas-liquid separator 136 and lines 112, 114, 116 and 118, Alternatively, the gas output port of gas-liquid separator 136 may be fluidly coupled to a suitable source of vacuum such a suction port of a vacuum pump. As a yet another alternative which may be suitable for ICE having a sufficiently high pressure of exhaust gases inside the exhaust duct 46, the gas output port of separator 136 may be in fluid communication with ambient atmosphere.

The reservoir 130 is a vessel adapted for collection of liquid water. Line 122 fluidly connects liquid outlet port of separator 136 to reservoir 130. The lower portion of the reservoir 130 is fluidly connected to a transfer line 178 leading to destinations for water delivery such as an electrolytic cell for generation of hydrogen by electrolysis of water, and/or an ICE coolant system, and/or a windshield washing system, and/or a system for delivery of liquid water into combustion chamber 34, and/or a system for generation of steam for delivery to a turbine portion of a turbocharger, and/or a humidifier for passenger compartment. Line 178 may also include a cation/anion exchange bed and/or other suitable means to remove contaminants and/or odors from water drained from reservoir 130.

During normal operation of the ICE/water source system 10, intake air stream 44 flows through the intake duct 32 and through the intake passage 22 into the combustion chamber 34. Furthermore, hydrocarbon-based fuel is supplied into the combustion chamber 34 and it is substantially combusted therein. Combustion products are exhausted from the combustion chamber 34 through the exhaust passage 24 into the exhaust duct 46 where they form an exhaust gas stream 92. As already noted above, products of hydrocarbon-based fuel combustion are very rich in water vapor. At normal operating conditions of the ICE system 15, the pressure p_{E} in the exhaust duct 46 may be substantially higher than the ambient atmospheric pressure and the pressure p_{I} in the intake duct 32 may be substantially lower than the ambient atmospheric pressure. As a result, there exists a substantial pressure difference Δp between the pressure p_{E} in the exhaust duct 46 and the pressure p_{I} in the intake duct 32. In particular, Δp=p_{E}−p_{I}. As already described above, the exhaust duct 46 may be fluidly connected to the intake duct 32. Therefore, the pressure difference Δp provides a motivation for a portion of the exhaust gas stream 92 to flow from the exhaust duct 46 into the intake duct 32 by following a path through the heat exchanger 128, vortex tube 120, gas-liquid separator 136, and interconnecting lines 112, 114, 116, and 118.

In particular, a portion of exhaust gases 92 flows from the exhaust duct 46 into line 112 thereby forming a process stream 142. Line 112 may include a filter which may substantially remove soot and particulates from the process stream 142. The process stream 142 is drawn through line 112 into the upstream port of heat exchanger 128. The heat exchanger 128 reduces the temperature of the process stream 142 to preferably less than 120 degrees Centigrade, thereby producing a cooler process stream 148 which exits through the down stream port of heat exchanger 128 into line 114. Most preferably, the temperature of the cooler process stream 148 is between 30 and 60 degrees Centigrade. The heat exchanger 128 may reject heat to ICE coolant, ambient air, or other suitable medium. The process stream 148 is drawn through line 114 and into the inlet port 172 of vortex tube 120 and it is cooled in the vortex tube to below its dew point, thereby forming a process stream 150 which exists the vortex tube through the cold outlet port 174. Cooling action inside the vortex tube 120 causes some of the water vapor herein to condense into liquid. A portion of the condensate may be in a form very small droplets which may be entrained by the gas flow. Some of the condensate may become separated from the gas flow by centrifugal forces and may become collected on the interior walls of the vortex tube 120. Preferably, the vortex tube 120 is designed and mounted so that liquid condensate is drained from the tube's interior walls by gravity into the cold outlet port 174. The process stream 150 which may contain both gaseous and liquid components exits the vortex tube through the cold outlet port 174 into line 116 and therethrough into the separator inlet port of gas-liquid separator 136. Inside the gas-liquid separator 136 the gas and liquid portions of the process stream 150 are substantially separated into a process stream 138 containing primarily gases and vapors and a process stream 146 containing primarily liquid water. Process stream 138 flows from the gas-liquid separator into line 118 and therethrough into the intake duct 32. Preferably, the gas-liquid separator 136 is designed and mounted so that process stream 146 may be drained by gravity into line 122 and therethrough into the reservoir 130 where the condensed water accumulates in a pool 144. As already stated above, in a variant of the invention the downstream end of line 118 may be fluidly connected to a source of sufficiently low pressure such as an inlet port of a vacuum pump rather than the intake duct 32. In such case, process stream 138 may flow from the gas-liquid separator into line 118 and therethrough into the source of sufficiently low pressure. If the vortex tube 120 has a gas-liquid separation capability, the gas-liquid separator 136 may be omitted and the liquid outlet port of such a vortex tube may be fluidly connected to the reservoir 130. The gas outlet port of such a vortex tube may be fluidly connected to intake duct 32 or a suitable source of sufficiently low pressure.

### EXAMPLE 2

Consider a hypothetical ICE/water source system 10 operated at a sea level with ambient atmospheric pressure of 760 Torr and at an ambient temperature of 40 degrees Centigrade (104 degrees Fahrenheit). To limit ICE pumping loss, ICE designers normally strive to keep the pressure drop in the exhaust duct 46 very small. This means that the pressure inside the exhaust duct 46 may be only slightly higher than the ambient atmospheric pressure. It may be assumed that the pressure in the exhaust duct at a point where it connects to line 112 is about 850 Torr. It may be also assumed that the pressure inside the intake duct is about 600 Torr or lower. Assuming that the exhaust gas stream 92 has a 850 Torr total pressure and it contains 16% water vapor by volume, the partial pressure of the water vapor therein is about 136 Torr which translates to a dew point of about 58 degrees Centigrade. Consider a process stream 142 being drawn from exhaust gas stream 92 and cooled in the heat exchanger 128 to a temperature of 60 degrees Centigrade. Because this temperature is above the dew point of 58 degrees Centigrade, no condensation is expected to occur in the heat exchanger 128. Cooled process stream 148 is be delivered from the heat exchanger 128 to the vortex tube 120. At the stated conditions, pressure ratio of the vortex tube is about 1.4. According to Exair Catalog No. 20, supra, a traditional vortex tube such as shown in FIG. 1 operated at 80% cold fraction and a pressure ration of 1.4 may reduce the temperature of inlet air by 15.6 degrees Centigrade. Therefore, it may be concluded that the temperature of process stream 150 leaving the vortex tube 120 is about 45 degrees Centigrade which is well below the dew point of 58 degrees Centigrade. As a result, water vapor in process stream 150 may condense into liquid water until the partial pressure of the residual water vapor drops to about 72 Torr, which is the partial pressure of water vapor that corresponds to a dew point of 45 degrees Centigrade. The fraction of the water vapor originally contained in process stream 142 that may be liquified in this process is estimated at (136−72)/136=0.47.

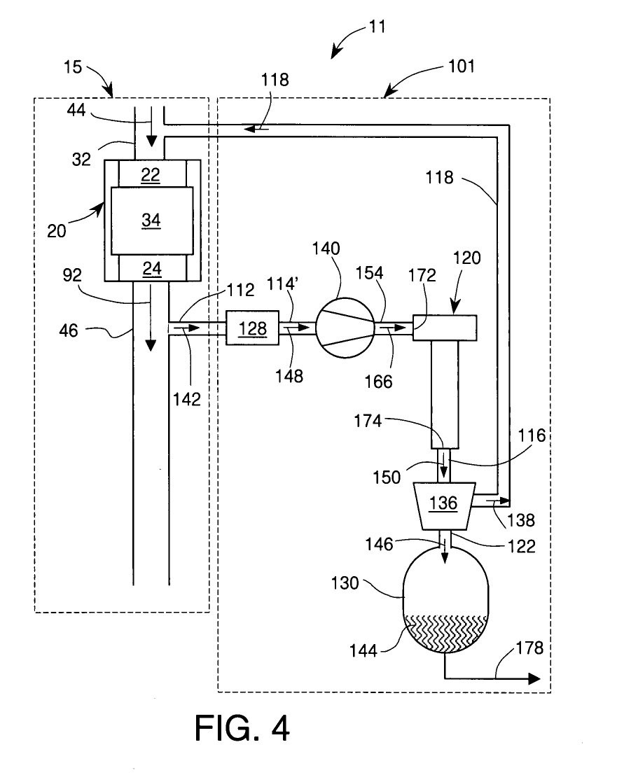

FIG. 4 shows an ICE/water source system 11 in accordance with a second embodiment of the subject invention. The ICE/water source system 11 comprises an ICE assembly 15 and a water source assembly 101. ICE assembly 15 may be of the same design and construction as the ICE assembly 15 used in the first embodiment and shown in FIG. 3. The water source assembly 101 may be substantially the same as the water source assembly 100 except that it further includes a compressor 140 disposed between the heat exchanger 128 and the vortex tube 120. The compressor 140 includes a suction port and a discharge port. The suction port of compressor 140 is fluidly connected to the downstream port of heat exchanger 128 by means of line 114′. The exhaust port of compressor 140 is fluidly connected to the inlet port 172 of vortex tube 120 by means of line 154. Compressor 140 may be of any suitable type including a piston compressor, diaphragm compressor, vane compressor, scroll compressor, roots blower, and turbo-compressor. Compressor 140 may be operated by an electric motor, ICE output shaft, air motor, turbine, vehicle drive shaft, or other suitable means. For example, the compressor 140 may be driven from the output shaft of ICE 20 by means of a belt, pulleys and a clutch (not shown). The clutch may be engaged or disengaged to operate the compressor 140 in accordance with demand for liquid water and/or ICE operating conditions. In a variant of the second embodiment, the downstream end of line 118 may be connected to the exhaust duct 46 or to a suction port of a vacuum pump, or it may be open to atmosphere instead of being connected to the intake duct 32 as shown in FIG. 4.

The ICE/water source system 11 operates in a similar manner as the ICE/water source system 10 with the notable exception that the compressor 140 now receives the process stream 148 and compresses it to produce a high-pressure process stream 166. The high-pressure process stream 166 flows through line 154 to the inlet port 172 of vortex tube 120 where its is cooled in a similar manner as in the water source assembly 100 except that the vortex tube 120 may now operate at a pressure ratio significantly higher than 1.4 and thus generate more cooling power. Line 154 may also include an aftercooler or other suitable cooling device to remove the heat added to the flow by the compressor 140.

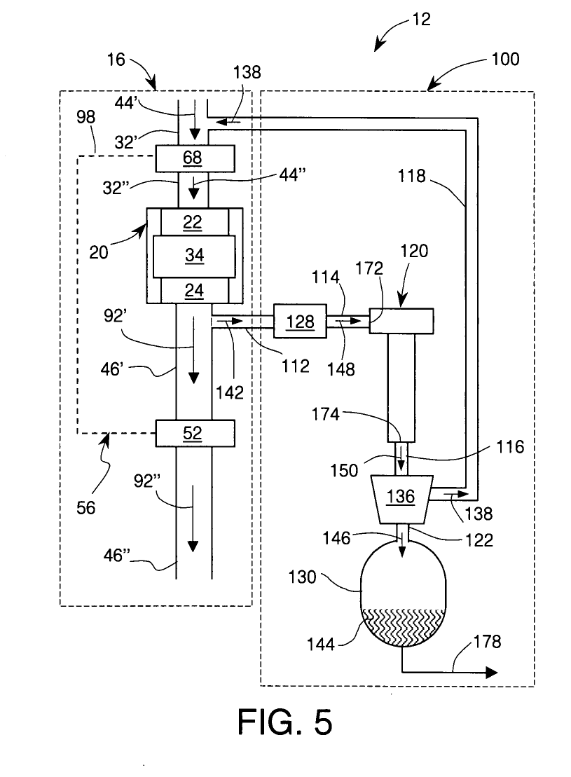

Referring now to FIG. 5 there is shown an ICE/water source system 12 in accordance with a third embodiment of the subject invention particularly suitable for use with a turbocharged ICE. The ICE/water source system 12 comprises an ICE assembly 16 and a water source assembly 100. The ICE assembly 16 further comprises an ICE 20, an exhaust gas turbocharger 56 having a turbine 52 and a turbo-compressor 68 operatively connected by a mechanical link 98, a high-pressure exhaust duct 46′, a low-pressure exhaust duct 46″, a low pressure intake duct 32′, and a high-pressure intake duct 32″. The high-pressure (inlet) port of turbine 52 is fluidly connected to the exhaust passage 24 by means of the high-pressure exhaust duct 46′. The low-pressure (discharge) port of turbine 52 is fluidly connected to the atmosphere by means of the low-pressure exhaust duct 46″. The inlet (low pressure) port of turbo-compressor 68 is fluidly connected to a source of intake air by means of the low-pressure intake duct 32′. The discharge port of turbo-compressor 68 is fluidly connected to the intake passage 22 by means of the high-pressure intake duct 32″. The water source assembly 100 may be of the same design and construction as the water source assembly 100 practiced with the first embodiment of the subject invention and shown in FIG. 3.

During normal operation of the ICE/water source system 12, intake air stream 44′ flows through the low-pressure intake duct 32′ into the turbo-compressor 68 where it is compressed and fed as a stream 44″ through the high-pressure intake duct 32″ and the intake passage 22 into the combustion chamber 34 of ICE 20. Furthermore, hydrocarbon-based fuel is supplied into the combustion chamber 34 and it is substantially combusted therein. Combustion products are exhausted from the combustion chamber 34 through the exhaust passage 24 into the high-pressure exhaust duct 46′ where they form an exhaust stream 92′. At typical operating conditions of the ICE system 15, the pressure PE in the high-pressure exhaust duct 46′ may be much higher than the ambient atmospheric pressure, and the pressure pi in the low-pressure intake duct 32′ may be substantially lower than the ambient atmospheric pressure. A large portion of exhaust stream 92′ may flow through the exhaust duct upstream portion onto the inlet (high pressure) port of the turbine 52 where it may be used to operate the turbine. The pressure and temperature of the exhaust stream 92′ may be generally reduced inside the turbine thereby producing an exhaust stream 92″ at reduced pressure and temperature which flows through the low-pressure exhaust duct 46″. Water source 100 operates in a similar manner as the water source 100 used in the first embodiment except that the stream 142 may be now provided at a substantially higher pressure. As a result, the vortex tube 120 may now operate at a pressure ratio PE/PI substantially higher than 1.4 and thus may deliver improved cooling power. Preferably, process stream 138 flowing in line 118 is provided to the low-pressure intake duct 32′ as shown in FIG. 5. Alternatively, line 118 may feed the stream 138 to the low-pressure exhaust duct 46″, or to ambient atmosphere, or other suitable location.

While only selected embodiments have been chosen to illustrate the present invention, it will be apparent to those skilled in the art from this disclosure that various changes and modifications can be made herein without departing from the scope of the present invention as defined in the appended claims. Furthermore, the foregoing description of the embodiments according to the present invention are provided for illustration only, and not for the purpose of limiting the present invention as defined by the appended claims and their equivalents. Thus, the scope of the present invention is not limited to the disclosed embodiments. In particular, the use of the subject invention is not limited automotive applications. For example, the subject invention may be used also in marine applications to generate fresh water.

The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

Moreover, terms that are expressed as “means-plus function” in the claims should include any structure that can be utilized to carry out the function of that part of the present invention. In addition, the term “configured” as used herein to describe a component, section or part of a device includes hardware and/or software that is constructed and/or programmed to carry out the desired function.

The term “intake air” used in this application should be given an broad interpretation. Thus, intake air is essentially a mixture of nitrogen, carbon dioxide, water vapor, oxygen, and inert gases, and it may also include ICE fuel vapor, nitrogen oxides, and hydrocarbons.

The term “exhaust gases” used in this application should be given an broad interpretation. Thus, exhaust gases may contain nitrogen, carbon dioxide, water vapor, oxygen, gases, ICE fuel vapor, nitrogen oxides, and hydrocarbons.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” and “includes” and/or “including” when used in this specification, specify the presence of stated features, integers, steps, operations, elements, and/or components, but do not preclude the presence or addition of one or more other features, integers, steps, operations, elements, components, and/or groups thereof.

The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

The term “suitable”, as used herein, means having characteristics that are sufficient to produce a desired result. Suitability for the intended purpose can be determined by one of ordinary skill in the art using only routine experimentation.

While only selected embodiments have been chosen to illustrate the present invention, it will be apparent to those skilled in the art from this disclosure that various changes and modifications can be made herein without departing from the scope of the present invention as defined in the appended claims. Furthermore, the foregoing description of the embodiments according to the present invention are provided for illustration only, and not for the purpose of limiting the present invention as defined by the appended claims and their equivalents. Thus, the scope of the present invention is not limited to the disclosed embodiments.

What is claimed is:

1. An internal combustion engine (ICE)/water source system comprising:
(a) an ICE assembly including an ICE, an intake duct for flowing intake air to said ICE, and an exhaust duct for flowing exhaust gases from said ICE; and,
(b) a water source assembly for generating liquid water, said water source assembly comprising:
(i) a heat exchanger having an upstream port and a downstream port, said upstream port being fluidly connected to said exhaust duct, said heat exchanger being adapted for receiving exhaust gases from said exhaust duct and cooling them to below a predetermined temperature value;
(ii) a vortex tube having an inlet port and a cold outlet port; said inlet port being fluidly connected to said downstream port of said heat exchanger and adapted for receiving cooled exhaust gases therefrom;
(iii) a gas-liquid separator having a separator inlet port, a liquid outlet port and a gas outlet port; said separator inlet port being fluidly connected to said cold outlet port and adapted for receiving fluid therefrom; said gas outlet port being in fluid communication with a location selected from the group consisting of said intake duct, a suction port of a vacuum pump, or ambient atmosphere; and
(iv) a reservoir fluidly connected to said liquid outlet port and adapted for receiving and collecting liquid water therefrom.

2. The ICE/water source system of claim 1 wherein said predetermined temperature value is about 120 degrees Centigrade.

3. The ICE/water source system of claim 1 wherein said cold outlet port is in fluid communication with a location having a pressure value such that the ratio of pressure value in said inlet port and the pressure value in said cold outlet port is at least 1.4.

4. The ICE/water source system of claim 1 wherein said ICE assembly further comprises a coolant system having a liquid coolant; and wherein said vortex tube is adapted to rejecting heat to a medium selected from the group consisting of ambient atmospheric air, exhaust gas, and said liquid coolant.

5. The ICE/water source system of claim 1 further comprising a compressor disposed between said heat exchanger and said vortex tube; said compressor being fluidly connected to said downstream port of said heat exchanger and adapted for receiving cooled exhaust gases therefrom; said compressor being adapted for compressing said cooled exhaust gases received from said heat exchanger; and said compressor being fluidly connected to said inlet port and adapted for providing said compressed cooled exhaust gases thereinto.

6. The ICE/water source system of claim 1 wherein said liquid water is supplied to a device selected from the group consisting of a system for delivery of liquid water into ICE combustion chamber, a system for generation of steam for delivery to a turbine portion of a turbocharger, and a humidifier.

7. An internal combustion engine (ICE)/water source system comprising:
(a) an ICE assembly further comprising:
(i) an ICE having a combustion chamber, and
(ii) an exhaust duct for flowing exhaust gases from said combustion chamber; and,
(b) a water source assembly for generating liquid water, said water source assembly further comprising:
(i) a heat exchanger having an upstream port and a downstream port, said upstream port being fluidly connected to said combustion chamber, said heat exchanger being adapted for receiving a portion of said exhaust gases from said combustion chamber and cooling them to below a predetermined temperature value;
(ii) a vortex tube having an inlet port and a cold outlet port; said inlet port being fluidly connected to said downstream port of said heat exchanger and adapted for receiving said cooled exhaust gases therefrom; said vortex tube being adapted for further cooling said received cooled exhaust gases to induce condensation of liquid water therefrom;
(iii) a separator adapted for separating said liquid water; and
(iv) a reservoir adapted for receiving and collecting said liquid water.

8. The ICE/water source system of claim 8 wherein said ICE assembly further comprises an intake duct for flowing intake air to said ICE and wherein said gas outlet port is fluidly connected to said intake duct, a suction port of a vacuum pump, or ambient atmosphere.

9. The ICE/water source system of claim 8 further comprising a compressor; disposed between said heat exchanger and said vortex tube, said compressor being fluidly connected to said downstream port and adapted for receiving said cooled exhaust gases therefrom; said compressor being adapted for compressing said cooled exhaust gases received from said heat exchanger; and said compressor being fluidly connected to said inlet port and adapted for providing said compressed cooled exhaust gases thereinto.

10. An internal combustion engine (ICE)/water source system comprising:
(a) an ICE assembly further comprising:
(i) an ICE having a combustion chamber,
(ii) a low-pressure intake duct fluidly connected to a source of intake air,
(iii) a high-pressure intake duct fluidly connected to said combustion chamber,
(iv) a low-pressure exhaust duct fluidly connected to ambient atmosphere;
(v) a high-pressure exhaust duct fluidly connected to said combustion chamber, and
(vi) a turbocharger having a turbine and a turbo-compressor; said turbine having a low-pressure port fluidly connected to said low-pressure exhaust duct and a high-pressure port fluidly connected to said high-pressure exhaust duct; said turbo-compressor having a low-pressure port fluidly connected to said low-pressure intake duct and a high-pressure port fluidly connected to said high-pressure intake duct; and
(b) a water source assembly for generating liquid water, said water source assembly further comprising:
(i) a vortex tube having an inlet port and a cold outlet port;
(ii) a heat exchanger having an upstream port and a downstream port; said upstream port being fluidly connected to said high-pressure exhaust duct; said heat exchanger adapted for receiving exhaust gases from said high-pressure exhaust duct and cooling them to below a predetermined temperature value; said downstream port being fluidly connected to said inlet port and adapted for flowing said cooled exhaust gases thereinto; and
(iii) a gas-liquid separator having a separator inlet port, a liquid outlet port and a gas outlet port; said separator inlet port being fluidly connected to said cold outlet port and adapted for receiving fluids therefrom, and said gas outlet port being in fluid communication with a location selected from the group consisting of said low-pressure intake duct, said low-pressure exhaust duct, a suction port of a vacuum pump, and ambient atmosphere.

11. The ICE/water source system of claim 10 wherein said ICE assembly further includes a coolant system having a liquid coolant; and said vortex tube is adapted to rejecting heat to a medium selected from the group consisting of air, exhaust gas, and said liquid coolant.

12. The ICE/water source system of claim 10 wherein said vortex tube is adapted to production of cold output flow only.

13. An internal combustion engine (ICE)/water source system comprising:
(a) an ICE assembly including an ICE, an intake duct for flowing intake air to said ICE, and an exhaust duct for flowing exhaust gases from said ICE; and,
(b) a water source assembly for producing liquid water, said water source assembly comprising:
(i) a means for diverting a portion of said exhaust gases;
(ii) a heat exchanger adapted for pre-cooling said diverted exhaust gases to less than 120 degrees Centigrade;
(iii) a vortex tube adapted for receiving said pre-cooled exhaust gases from said means for pre-cooling and further cooling said pre-cooled exhaust gases to induce condensation of liquid water from water vapor contained in said exhaust gases; and
(iv) a means for separating said liquid water from said further cooled exhaust gases.

14. The water generating system of claim 13 further comprising a compressor for increasing the pressure of said pre-cooled exhaust gases received by said vortex tube.

15. The ICE/water source system of claim 13 wherein said means for separating said liquid water from said further cooled exhaust gases are also adapted for flowing cooled exhaust gases to a destination selected from the group consisting said ICE intake duct, a suction port of a vacuum pump, and ambient atmosphere.

16. The ICE/water source system of claim 12 further including an exhaust gas turbocharger having a turbine; said turbine having a high-pressure port being fluidly connected to said exhaust duct and adapted for receiving exhaust gases therefrom.

17. A method for generating liquid water from exhaust gases of an internal combustion engine having a combustion chamber, said method comprising the acts of:
a. operating said internal combustion engine;
b. flowing exhaust gases from said combustion chamber;
c. diverting at least a portion of said exhaust gases;
d. cooling said diverted exhaust gases in a heat exchanger to a temperature below 120 degrees Centigrade;
e. further cooling said cooled diverted exhaust gases in a vortex tube to induce condensation of liquid water therefrom;
f. substantially separating and collecting said liquid water; and
g. conveying said further cooled diverted exhaust gases to a destination selected from the group consisting of ambient atmosphere, said combustion chamber, and a suction port of a vacuum pump.

18. The method of claim 17 wherein said cooled exhaust gases are compressed in a compressor to a pressure substantially higher than atmospherics pressure prior to being further cooled in said vortex tube;

19. An internal combustion engine/water source system, said system comprising:
an internal combustion engine having a combustion chamber, and an exhaust conduit in fluid communication with said combustion chamber and adapted for flowing exhaust gases therefrom;
a heat exchanger adapted for receiving a portion of said exhaust gases and cooling them to below 120 degrees Centigrade;
a vortex tube adapted for receiving and further cooling said cooled exhaust gases to condense into liquid water at least a portion of water vapor contained in said exhaust gases.

20. An apparatus for generation of water from exhaust gases of internal combustion engine, said apparatus comprising:
a heat exchanger having an upstream port and a downstream port, said heat exchanger being adapted for receiving exhaust gases from an internal combustion engine, said heat exchanger being adapted for cooling said exhaust gases and flowing said cooled exhaust gases to said downstream port;
a vortex tube having an inlet port and a cold outlet port, said inlet port being in fluid communication with said downstream port and adapted for receiving cooled exhaust gases therefrom; said vortex tube being adapted for further cooling said cooled exhaust gases to induce condensation of liquid water therefrom; and
a means for separating said liquid water.

21. The apparatus of claim 20 further comprising a compressor adapted for increasing the pressure of said cooled exhaust gases received by said inlet port.
